(19) United States
(12) Patent Application Publication
(10) Pub. No.: US 2009/0159853 A1
(43) Pub. Date: Jun. 25, 2009

(54) COLLOIDAL TEMPLATING PROCESS FOR MANUFACTURE OF HIGHLY POROUS CERAMICS

(75) Inventors: Suvankar Sengupta, Hilliard, OH (US); Ramachandra Revur, Columbus, OH (US)

Correspondence Address: HAHN LOESER & PARKS, LLP, One GOJO Plaza, Suite 300, AKRON, OH, 44311-1076, US

(73) Assignee: NANODYNAMICS, INC., Buffalo, NY (US)

(21) Appl. No.: 12/064,362

(22) PCT Filed: Aug. 24, 2006
(86) PCT No.: PCT/US2006/033261

§ 371 Date: Oct. 29, 2008

Related U.S. Application Data
(60) Provisional application No. 60/711,420, filed on Aug. 24, 2005.

(51) Int. Cl. H01B 1/00; C04B 35/00; C04B 33/00; C04B 38/00

(52) U.S. Cl. 252/500; 501/97.1; 501/94; 501/80

(57) ABSTRACT

A method for forming porous ceramic objects is provided, in which a suspension of ceramic precursor particles in a solution of gelatin is allowed to gel in the desired shape, and is then dried and sintered to the desired level of porosity.

### REFERENCE TO RELATED APPLICATIONS

The present invention claims priority to U.S. Provisional Application No. 60/711,420 filed Aug. 24, 2005, which is incorporated herein by reference.

### FIELD OF THE INVENTION

The technical field of the invention is ceramic materials generally, more particularly the formation of porous ceramic materials for use in fuel cells, catalysts, filtration media, and other applications.

### BACKGROUND OF THE INVENTION

Ceramics, fundamentally, result from the sintering together of refractory particles into a monolithic mass. While monolithic ceramic blanks can be machined into almost any desired form, their extremely hard and sometimes brittle nature makes machining a difficult and expensive process. For this reason, it is usually preferred that the particles be sintered directly into the desired final form. A variety of ceramic forming methods have been developed to meet the widely varying demands put upon ceramic product.

The selection of a ceramic-forming operation for making a particular ceramic object is dependent on many considerations, among them the size, shape, and dimensional tolerances of the product, the identity of the ceramic, the requisite microstructure, and levels of reproducibility required, as well as capital investment and productivity considerations. Among the more common ceramic-forming processes that have been developed to manufacture ceramic items are pressing, plastic forming, and colloidal processing.

Pressing is the simultaneous compaction and shaping of a powder or granular material confined in a rigid die or a flexible mold. Powder feed for industrial pressing is in the form of controlled granules containing processing additives, generally produced by spray drying or other granulation method. Coarse granular compositions containing a binder are commonly in the form of a poorly flowing, semi-cohesive mass. Because it has the ability to produce parts ranging widely in size and shape, with close tolerances and with essentially no shrinkage, pressing is the most widely-practiced forming process. Dry pressing (uniaxial), cold isostatic pressing (CIP), combination pressing (both uniaxial and isostatic), and roll pressing are some of the methods used. Products produced by pressing include a wide variety of magnetic and dielectric ceramics, fine-grained technical alumina (e.g., clip carriers and spark plugs), engineering ceramics (e.g., cutting tools), refractory sensors, ceramic tile and porcelain products, grinding wheels, and structural clay products.

Plastic forming of ceramic bodies has traditionally been done using processes such as extrusion, plastic pressing, and jiggering. These forming processes generally rely on plasticized ceramic precursors containing organic binders to obtain the needed plasticity, and require large quantities of polymers to confer the necessary rheological flow characteristics to make the ceramic shape. After forming, the plasticizing component must be removed from the ceramics, which is commonly done by pyrolysis during calcination or sintering. Examples of plastic forming processes include wet pressing, extrusion, jiggering, injection molding and tape calendaring. Products formed by extrusion include hollow furnace tubes, tubes for electronic, electrical and magnetic applications, honeycomb supports for catalysts, transparent alumina tubes for lamps, flat substrates and tile products. Injection molding is used to fabricate complex shapes such as multi-vane turbine rotors and small electronic components. Tape calendaring has found applications in making parts for solid oxide fuel cells and oxygen generators.

Colloidal processing offers the potential to reliably produce solid preforms or “green bodies” through careful control of initial colloid structure and its evolution during fabrication. This approach involves five steps: (1) powder synthesis, (2) preparation of a colloid, (3) consolidation into the desired shape, (4) removal of the solvent, and (5) densification. As with all forming processes, any inhomogeneities or defects introduced during any of the steps of the fabrication process can either persist or be exacerbated during the densification process.

Consolidation of a colloidal suspension into a dense homogeneous preform or green part is the central feature of colloidal processing. In this approach, the preform or the green part is formed directly from the colloid, which forms a shape in a mold. Once shaped, the rheological properties of the as-formed body must be altered dramatically to permit handling and further processing without deforming or cracking. Solidification can be induced by partial removal of the liquid, as is done in pressure filtration, slip casting, and centrifugal casting, or by direct coagulation without liquid removal, as is done in gel casting and related methods.

Gel casting involves the addition of a gelling agent to a fluid suspension of a powdered ceramic precursor. The liquid is poured into a mold or coated on a surface, and then gelled, usually by lowering the temperature. Clay-like compositions suitable for injection molding may also be gelled prior to drying and sintering (U.S. Pat. No. 5,258,155). Once gelled, the green body retains its shape and can be carefully dried (see U.S. Pat. No. 5,513,447). When the dried green body is sintered, the gelling agent is removed by pyrolysis. The gelling agent is most commonly a polysaccharide, such as carrageenan (U.S. 2006/0054856), agar (U.S. Pat. No. 6,171,360, U.S. Pat. No. 6,146,560 and U.S. Pat. No. 6,316,530), agarose (U.S. Pat. No. 4,734,237 and U.S. Pat. No. 5,746,957), or synthetic polyacrylates (U.S. Pat. No. 5,900,201). Protein gelling agents such as gelatin have more rarely been used (EP 1359131, U.S. Pat. No. 6,986,810). In all cases, the final ceramic products are sintered to high density.

Consolidation into a dense body by pressure filtration involves the formation of a dense particulate layer at the colloid-filter interface, as the liquid flows through the filter in response to an applied pressure. In slip casting, a porous mold is used, and local capillary pressure generated by the porous mold removes the liquid. In centrifugal casting, centrifugal force is used to separate the liquid from the particles. The preform that is formed using these processes will generally have a higher green density than the volume fraction of the particles in the liquid. Remaining liquid is then removed during the drying process.

Many organic substances, in the form of binders, plasticizers, gelling agents, dispersants and surfactants, are introduced during ceramic forming processes, and the quantity of these organics is an important issue. The volume of organics present in a green body varies with the process, being highest in injection molding and lowest in dry pressing. The uses of larger amounts of organic materials make powder packing less dense and generate higher degree of shrinkage during down-stream heat treatments, which contributes to the non-uniformity of these products. Excessive binder creates voids and clusters of fine voids, and makes removal more difficult. Minimizing the amount of binder is an important and common goal in dry pressing process development.

Injection molding uses a mixture of ceramic powder and thermoplastic binder, which flows only with difficulty under standard forming temperature and pressure. A high volume fraction of binder is used to improve flow rates. Bubbles, weld lines (or weld planes), and process impurities are often introduced, resulting in large defects. In slip casting, a suspension with even higher fluidity is needed in order to make mold filling possible, but absorption of water by the usual plaster mold tends to interfere with the uniform migration and orientation of the ceramic powder. In dry pressing, collapse strength, humidity content, and die friction of dry agglomerates affect the uniformity of pressed part and void formation. Density gradients arising from wall friction, and capping resulting from the spring-back of powders, are common defects found in dry-pressed parts. Extrusion is limited to objects of constant cross section, preferably with high symmetry, such as rods, tubes, bricks, structural beams, and the like. Common extrusion defects include tearing at edges or surfaces, due to low cohesive strength; segregation, due to the flow of water under differential pressure; cracking, due to differential shrinkage and poor mixing; laminations, due to differential shrinkage; and warping, most likely arising during drying or firing.

Where hard and dense ceramic products are the goal, much of the focus in ceramic processing research is directed to the problems of shrinkage, warping, and cracking, and the emphasis has been on minimizing the volume fraction of solvents, organic binders and additives without compromising the rheological properties needed for the forming process.

Porous ceramic materials have a variety of industrial applications, including semi-conductors, catalysts, fuel cells and filtration systems. In these applications, pore morphology, size and distribution play critical roles in the performance of the ceramic material, and dimensional stability and precision are usually less of a concern. Filtration systems obviously rely heavily on pore size and distribution, and in fuel cell applications the flow of fuel, oxygen, and combustion gases are dependent on the geometry and topology of the pores. For example, the cathodes in a solid oxide fuel cells generally need a porosity of at least 30-35%, so as to allow for sufficient flow of air or oxygen to the electrolyte. Efficient mass transfer of gases through the body of catalyst supports is likewise a primary design consideration.

Several approaches are currently being used for fabrication of porous ceramic materials. In one approach, pore forming agents such as polymer, starch or wood particles are added to ceramic precursors (see for example EP 1359131). As the ceramic is heat treated, these “sacrificial” pore forming agents burn out and leave pores which reflect the size and morphology of the agents. In another approach, the ceramic slurry is infiltrated into a reticulated polymeric foam. The resulting preform is then dried, and during heat treatment, the foam is burned out to leave a ceramic with the desired porosity. Yet another approach relies on formation of gas bubbles in a ceramic slurry or suspension which is then coagulated, with the trapped bubbles providing the pores in the finished product.

However, these approaches tend to provide large, randomly distributed, irregular and non-uniform pores that ultimately diminish the efficiency of ceramic articles. The methods are also not entirely compatible with the various casting techniques described above, introducing complications to the processes and frequently generating defects in the finished products. Especially in the field of fuel cell elements, there remains a need for methods to produce ceramics with uniform, micro-scale pores.

### SUMMARY OF THE INVENTION

The invention provides porous ceramic objects having a plurality of interconnected pores, the pores having an average diameter between 5 μm and 20 μm. The interconnected system of pores may constitute between 10 and 60% of the total volume of the material. The invention also provides a method of making these porous materials using a casting technique, which provides excellent control over the size and shape of the finished ceramic articles.

The method includes the steps of (a) preparing a suspension of ceramic precursor particles in an aqueous network-forming solution; (b) shaping the suspension into a preform of the porous ceramic object; allowing the network-forming solution to gel; (d) drying the resulting solid preform; and (e) sintering the preform at a temperature and for a time sufficient to cause the precursor particles to form a porous ceramic object. The network-forming solution comprises gelatin, and the preform is sintered only for a time sufficient for the ceramic object to attain a density between 40% and 90% of the maximum theoretical density.

The present inventors have discovered that removal of the water during drying, and pyrolytic removal of the gelling agents during subsequent heat treatment, results in a solid ceramic product with an extensive and interconnected pore structure. Such materials were not obtained in prior art processes.

### BRIEF DESCRIPTION OF THE FIGURES

FIG. 1 is a micrograph of a portion of a fuel cell cathode tube which was prepared according to one embodiment of the invention.

FIG. 2 is a higher-magnification micrograph of a portion of the cathode tube of FIG. 1.

### DETAILED DESCRIPTION OF THE INVENTION

The invention provides a porous ceramic structure containing a plurality of interconnected pores. In some embodiments, each pore is a channel-like interconnected pore that may run at any angle in the ceramic structure. In certain embodiments, the pores are distributed in at least one portion of the structure, while in other embodiments the pores are distributed throughout the entire structure.

In certain embodiments, the diameter of at least a majority of the pores may be substantially uniform. In one embodiment, the diameter of more than 90% of the pores ranges from about 5 μm to about 20 μm. In another embodiment, the diameter of more than 80% of the pores ranges from about 5 μm to about 15 μm. In yet another embodiment, the diameter of more than 70% of the pores is less than about 15 μm.

The dimensions and topology of the pore structure may be altered by addition of one or more pore-modifying agents to the network-forming solution. Particularly suitable pore-modifying agents are water-soluble organic polymers having a substantial charge at neutral pH, including but not limited to chitosan, pectin, agar, alginate, carrageenan, polyacrylates, polylactates, and the like.

The ceramic structure of the invention is used for various applications such as fuel cells, semi-conductors and filtration systems. In a particular embodiment, the ceramic structure is an electrode of a fuel cell, for example, a cathode of a solid-oxide fuel cell.

Suitable ceramic precursor particles include, in general, any known powdered or particulate refractory precursor known in the art to be suitable for preparation of a ceramic material by sintering. These precursors are typically metal and mixed metal oxides and nitrides. Examples include, but are not limited to, metal and mixed metal manganates and manganites, metal and mixed metal nickelates, metal and mixed metal cobaltites, metal and mixed metal chromates, lanthanum strontium manganate, lanthanum calcium manganate, yttrium stabilized zirconia, gadolinium-doped ceria, alumina, mullite, lanthanum strontium manganite, lanthanum strontium manganese cobaltite, lanthanum strontium ferrite cobaltite, samarium strontium cobaltite, and silicon nitride, and combinations thereof. These materials may optionally be modified or doped with additional elements to achieve a desired physical, chemical, or electrochemical property.

The amount of gelatin is preferably between 5 and 20% by weight relative to the amount of water. The maximum amount of gelatin giving a workable suspension will vary, depending on the molecular weight of the gelatin employed, the ionic strength of the aqueous system, and the amount of suspended solids, as is known in the art (J. H. Hone, A. M. Howe, J Colloid Interface Sci. 2002, 251:193-199).

The method includes the step of shaping the colloidal suspension to form a preform of the porous ceramic structure. The term “preform,” as used herein, means the colloidal suspension shaped to the approximate contour and thickness desired in the finished part of the porous ceramic structure, and then gelled. In one embodiment, the colloidal suspension is converted to a preform by introducing the suspension into a mold. The mold may be maintained at a temperature below the gelling temperature of the gelatin solution but above 0° C., in which case it may take 12 hours or more for the network-forming solution to solidify. Preferably, the mold and the suspension within are cooled down to 0° C. or below, which leads to the rapid coagulation of the colloidal suspension into a solid preform with concomitant freezing of the water. The frozen preform exhibits great mechanical strength, as would be expected, but this mechanical strength is surprisingly retained upon warming the preform to room temperature.

Other methods of shaping may be employed. For example, where a layer of porous ceramic is desired to be formed upon a substrate (such as an electrolyte tube or catalyst support), the substrate may be sprayed with or dipped in the liquid suspension of ceramic precursor powder, optionally frozen, and then dried; it may be sprayed or dipped repeatedly to build up a thicker coating.

The method also includes the steps of drying the solidified preform, and then sintering the dried preform at a temperature and for a time sufficient to cause the precursor particles to form a porous ceramic object in final-form. During this step, the solid preform is dried and subsequently heat-treated at a predetermined temperature. The drying may be carried out at atmospheric pressure, and at any temperature below the melting temperature of the gelled preform. The sintering time and temperature may range in general from about 800° C. to about 2000° C., depending on the particular ceramic precursor. Appropriate sintering temperatures for various ceramics are well known in the art. The sintering time will generally range from about 1 hr to about 4 hr, depending on the particular ceramic employed and the particular degree of porosity desired, and will be selected by the practitioner so as to obtain the desired degree of porosity at the selected temperature. Shorter times may lead to a density that is about 50% of the theoretical density for the ceramic, while longer times and higher temperatures will lead to correspondingly more dense materials, ceramics with up to about 90% of theoretical density may be obtained, leaving the ceramic with less than about 10% porosity.

The following examples are provided to further illustrate the invention described herein.

### Example 1

The invention has been applied to make cathode tubes for use in solid oxide fuel cells. A cathode tube is essentially a 60-65% dense (of the theoretical density) ceramic tube fabricated from a mixture of electronic and ionic conductors such as modified lanthanum calcium magnate (LCM). Fuel cell cathodes need to have a porous structure with a porosity of about 30-35% to allow for sufficient flow of air or oxygen to the electrolyte. The pores are not only important in bringing air/oxygen to the cathode/electrolyte interface, but also increase the surface area of the electrode interacting with oxygen. More reducing sites produce more electrons or oxygen ions, and a higher current density for the cell. With a proper design of the microstructure, specifically an interconnected pore structure, one can expect a significant improvement in the performance of a fuel cell.

In order to fabricate a fuel cell cathode tube, gelatin (7.5 g) was added to deionized water (49 ml) and the mixture was heated to 40-50° C. with gentle stirring in order to dissolve the gelatin. Once a visually clear solution is obtained, a doped lanthanum calcium manganate powder (1-5 μm nominal diameter, 400 g) was added. The resulting suspension was then injected into a tube mold preheated to 40° C. The mold was cooled to about −5° C. to freeze the water and coagulate the gelatin, resulting in a solid tubular preform. The preform was removed from the mold, and water in the structure was removed by air-drying at room temperature for 20 hours. The tube was then sintered at 1400° C. for 3 hours to achieve the desired porosity. Electrolyte and anode layers were then applied by methods known in the art, to produce a functional fuel cell element.

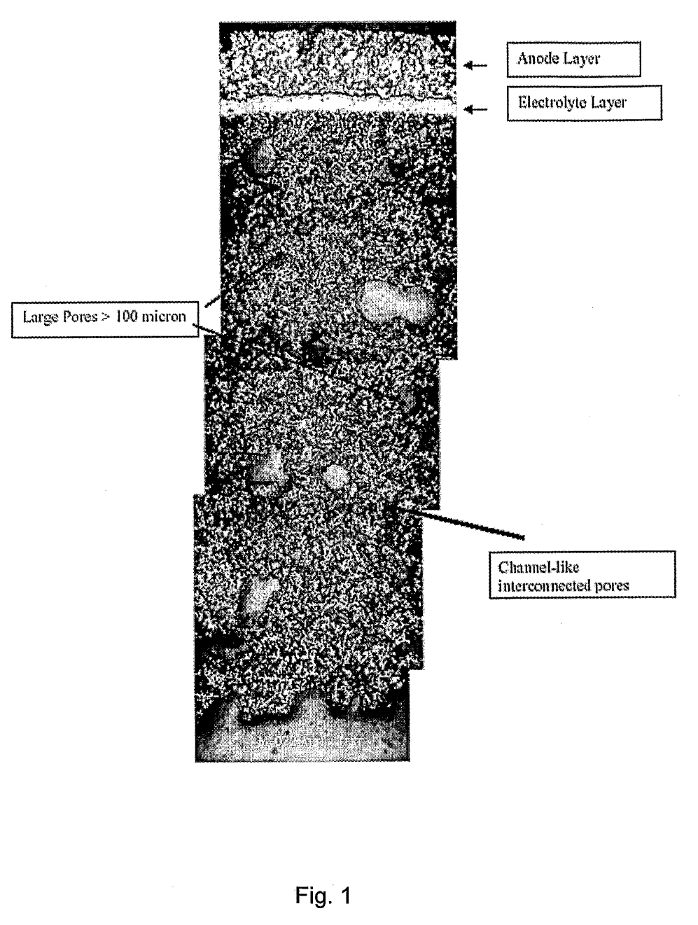

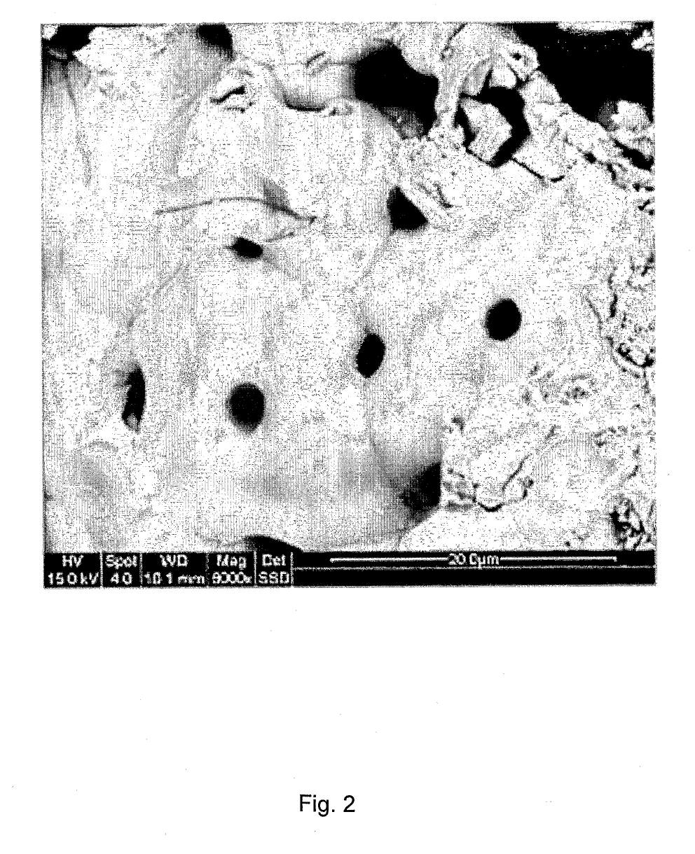

FIG. 1 shows the microstructure of a cathode tube prepared by this method. Three types of pores were observed:
1. Irregular or spherical pores with size ranging from 20-100 μm. These pores may have resulted from trapped gases, localized water vapor, localized destabilization of the suspension, improper mixing or segregation during cooling.
2. Channel-like connected pores with diameter from about 5 to about 20 μm. These pores, which reflect the topology of the network structure formed by the gelatin, are generally revealed with careful polishing of the samples, as in this case. Bright areas are solid ceramic, while dark areas in the micrograph are the open regions of the interconnected pore network.
3. Smooth, often circularly-shaped pores about 3-5 μm in diameter (see FIG. 2). These pores, which are believed to result from the incomplete sintering of the solid particles, appear to be the remnants of spaces between uniformly packed primary particles of ceramic precursor.

The above process was also used to produce catalyst support tubes made from yttrium stabilized zirconia and cerium oxide, and aeration tubes made from alumina.

### Example 2

A gelatin-chitosan mixture was employed to produce a different cellular structure, having differently-connected porosity compared to the ceramic obtained with pure gelatin. In this experiment, gelatin (3.64 g) and chitosan (0.20 g) were dissolved in deionized water (49 ml) with stirring at 40-50° C. Once a visually clear solution was obtained, doped lanthanum calcium manganate powder (1-5 μm nominal diameter, 410 g) was added. The resulting suspension was then injected to a mold. The mold was opened and the preform was removed, dried, and sintered as before. Microscopic examination revealed a greater number of connections between pores, compared to the product of Example 1.

### Example 3

Gelatin (3.64 g) and agar (0.20 g) are dissolved in deionized water (49 ml) with stirring at 40-50° C. Once a clear solution is obtained, cerium oxide powder (1-5 μm nominal diameter, 410 g) is added. The resulting suspension is then injected to a pre-heated mold, and allowed to cool. The mold is opened and the preform is removed, dried, and sintered as described above.

### Example 4

By the method of example 1, but using aluminum oxide powder, a porous alumina was prepared by sintering at 1500° C. for 2 hours.

### Example 5

By the method of example 1, but using gadolinium-doped ceria (20% Gd) powder, porous Gd—Ce ceramics were prepared by sintering at 1300° C. for 2-4 hours.

While the present invention has been described in some detail for purposes of clarity and understanding, it will be appreciated by one skilled in the art, from a reading of the disclosure, that various changes in form and detail can be made without departing from the true scope of the invention as set forth in the appended claims. In particular, it should be understood that the detailed description and the specific examples, while disclosing preferred embodiments of the invention, are given by way of illustration only, and do not in any way constitute limits on the scope of the invention as claimed.

What is claimed is:

1. A method for making a porous ceramic object, comprising:
(a) preparing a suspension of ceramic precursor particles in an aqueous network-forming solution;
(b) shaping said suspension into a preform of the porous ceramic object;
(c) allowing said network-forming solution to gel, so as to form a solidified preform;
(d) drying said solidified preform; and
(e) sintering said preform at a temperature and for a time sufficient to cause said precursor particles to form a porous ceramic object;
wherein the network-forming solution comprises gelatin, and wherein the preform is sintered for a time sufficient for the ceramic object to attain a density between 40% and 90% of the maximum theoretical density.

2. The method of claim 1, wherein the amount of gelatin is between 5% and 40% by weight relative to water.

3. The method of claim 2, wherein the amount of gelatin is between 10% and 30% by weight relative to water.

4. The method of claim 1, wherein the preform is sintered until the ceramic object has a density between 50% and 80% of the maximum theoretical density.

5. The method of claim 2, wherein the preform is sintered until the ceramic object has a density between 50% and 80% of the maximum theoretical density.

6. The method of claim 3, wherein the preform is sintered until the ceramic object has a density between 50% and 80% of the maximum theoretical density.

7. The method of any one of claims 1-6, wherein the network-forming solution further comprises a pore-modifying agent.

8. The method of claim 7, wherein the pore-modifying agent is chitosan.

9. The method of any one of claims 1-6, wherein the shaping is accomplished by introducing the suspension into a mold.

10. The method of any one of claims 1-6, wherein a plurality of the ceramic particles comprise a ceramic precursor selected from the group consisting of metal oxides, mixed metal oxides, and silicon nitride.

11. The method of claim 10, wherein a plurality of the ceramic particles comprise a ceramic precursor selected from the group consisting of metal and mixed metal manganates and manganites, metal and mixed metal nickelates, metal and mixed metal cobaltites, metal and mixed metal chromates, lanthanum strontium manganate, lanthanum calcium manganate, yttrium stabilized zirconia, gadolinium-doped ceria, alumina, mullite, lanthanum strontium manganite, lanthanum strontium manganese cobaltite, lanthanum strontium ferrite cobaltite, samarium strontium cobaltite, and silicon nitride.

12. The method of any one of claims 1-6, wherein the ceramic object is a fuel cell electrode.

13. A porous ceramic object prepared according to the method of any one of claims 1-6.

14. A fuel cell electrode prepared according to the method of any one of claims 1-6.

15. A porous ceramic object having a plurality of interconnected pores, wherein the pores have an average diameter between 5 μm and 20 μm and constitute between 10 and 60% of the volume of the object.

16. The ceramic object of claim 15, wherein the pores constitute between 20 and 50% of the volume of the object.

17. The ceramic object of claim 16, wherein the pores constitute between 30 and 40% of the volume of the object.
